(19) United States
(12) Patent Application Publication
(10) Pub. No.: US 2018/0203300 A1
(43) Pub. Date: Jul. 19, 2018

(54) DISPLAY DEVICE

(71) Applicant: InnoLux Corporation, Miao-Li County (TW)

(72) Inventors: Chun-Hsu LIN, Miao-Li County (TW); Ming-Feng HSIEH, Miao-Li County (TW); Ming-Ta YANG, Miao-Li County (TW)

(21) Appl. No.: 15/845,053

(22) Filed: Dec. 18, 2017

(30) Foreign Application Priority Data
Jan. 17, 2017 (CN) 201710040908.9

(51) Int. Cl. G02F 1/1335; F21V 8/00

(52) U.S. Cl. CPC G02F 1/133602; G02B 6/0011

(57) ABSTRACT

A display device includes a display panel and a backlight module. The backlight module is disposed corresponding to the display panel and includes a light guiding unit and a light-emitting unit. The light guiding unit has a light input surface, and the light-emitting unit is disposed adjacent to the light input surface along a first direction. The light-emitting unit has a plurality of first light-emitting units, a plurality of second light-emitting units and a substrate. The first light-emitting units and the second light-emitting units are disposed on the substrate along the first direction and emit light into the light guiding unit through the light input surface. An FWHM (full width at half maximum) angle of an illumination of at least one of the first light-emitting units is different from an FWHM angle of an illumination of at least one of the second light-emitting units.

### CROSS REFERENCE TO RELATED APPLICATIONS

This Non-provisional application claims priority under 35 U.S.C. § 119(a) on Patent Application No(s). 201710040908.9 filed in People's Republic of China on Jan. 17, 2017, the entire contents of which are hereby incorporated by reference.

### BACKGROUND

### Technical Field

This disclosure relates to a display device that can control the local dimming by the edge-type light source.

### Related Art

With the development of technologies, flat display devices have been widely applied to various fields. Due to the advantages such as low power consumption, less weight, compact size and less radiation, the liquid crystal display (LCD) devices have gradually replaced the traditional cathode ray tube display (CRT) display devices and been applied to various electronic products, such as mobile phones, portable multimedia devices, notebook computers, liquid crystal TVs and liquid crystal screens. Since the liquid crystal molecules cannot emit light spontaneously, a backlight module is needed to provide light to pass through the LCD panel to enable the pixels of the panel to display colors for forming an image.

The conventional backlight module usually contains a plurality of light-emitting diodes (LED) for providing the backlight source of the LCD panel. In a recent backlight module with a local dimming control function, a dimming control method is applied to analyze the image content and then to decrease the energy for the dark region and increase the energy for the bright region, thereby achieving the goals of compensating the image, enhancing the dynamic contrast and reducing the power consumption.

The conventional dimming control method can divide the backlight module into multiple regions for local dimming on the two sides corresponding to the light guiding unit (light input surface). However, in the direction perpendicular to the light input surface, one or two regions are available. This design can limit the possible regions in the local dimming procedure.

SUMMARY

An objective of the disclosure is to provide a display device that could control the local dimming by the edge-type light source, thereby could compensating the image, enhancing the dynamic contrast or reducing the power consumption.

The present disclosure provides a display device including a display panel and a backlight module. The backlight module is disposed corresponding to the display panel and includes a light guiding unit and a light-emitting unit. The light guiding unit has a light input surface, and the light-emitting unit is disposed adjacent to the light input surface along a first direction. The light-emitting unit has a plurality of first light-emitting elements, a plurality of second light-emitting elements and a substrate. The first light-emitting elements and the second light-emitting elements are disposed on the substrate along the first direction and emit light into the light guiding unit via the light input surface. An FWHM (full width at half maximum) angle of an illumination of at least one of the first light-emitting elements is different from an FWHM angle of an illumination of at least one of the second light-emitting elements.

The present disclosure also disclosure a display device including a display panel and a backlight module. The backlight module is disposed corresponding to the display panel and includes a light guiding unit and a light-emitting unit. The light guiding unit has a light input surface, and the light-emitting unit is disposed adjacent to the light input surface along a first direction. The light-emitting unit has a plurality of first light-emitting elements, a plurality of second light-emitting elements and a substrate. The first light-emitting elements and the second light-emitting elements are disposed on the substrate along the first direction and emit light into the light guiding unit via the light input surface. A second direction is a direction perpendicular to the light input surface. An included angle between the second direction and an extension direction of a maximum illumination of at least one of the first light-emitting elements is different from an included angle between the second direction and an extension direction of a maximum illumination of at least one of the second light-emitting elements.

As mentioned above, the display device of the disclosure has the light-emitting elements with at least two different FWHM angles of illuminations or at least two different tilting angles, so that the light emitted from the light-emitting elements can form the maximum brightness at different locations inside the light guiding unit. This configuration can increase the available numbers of local dimming regions, thereby achieving the goals of compensating the image, enhancing the dynamic contrast or reducing the power consumption.

### BRIEF DESCRIPTION OF THE DRAWINGS

The embodiments will become more fully understood from the detailed description and accompanying drawings, which are given for illustration only, and thus are not limitative of the present disclosure, and wherein:

FIG. 1 is a side view of a light guiding unit according to an embodiment of the disclosure;

FIG. 2A is a schematic diagram showing the illumination values of the light-emitting unit in different angles;

FIGS. 2B to 2D are side views of the light guiding units and light-emitting elements in different embodiments;

FIG. 3 is a side view of a display device according to an embodiment of the disclosure;

FIG. 4A is a top view of a light guiding unit and a light-emitting unit in the backlight module of the display device as shown in FIG. 3;

FIG. 4B is a schematic diagram showing a light-emitting unit of FIG. 4A;

FIG. 4C is a top view of a light guiding unit and a light-emitting unit according to another embodiment of the disclosure;

FIG. 4D is a schematic diagram showing a light-emitting unit of FIG. 4C;

FIG. 4E is a block diagram of a backlight module according to an embodiment of the disclosure;

FIGS. 5A and 5C are schematic diagrams showing the light-emitting units of different aspects;

FIG. 5B is a side view of the light guiding unit and the light-emitting element of another embodiment;

FIG. 5D is a top view of the light guiding unit and the light-emitting element according to another embodiment of the disclosure;

FIG. 6 is a top view of the light guiding unit and the light-emitting unit according to another embodiment of the disclosure;

FIGS. 7A and 7B are side views of the backlight modules of different aspects of the disclosure;

FIGS. 8A to 8C are side views of the display devices of different embodiments of the disclosure; and

FIGS. 9A to 9C are schematic diagrams showing the light patterns of three different light sources.

### DETAILED DESCRIPTION OF THE DISCLOSURE

The embodiments of the disclosure will be apparent from the following detailed description, which proceeds with reference to the accompanying drawings, wherein the same references relate to the same elements. Moreover, the drawings of all implementation are schematic, and they do not mean the actual size and proportion. The terms of direction recited in the disclosure, for example up, down, left, right, front, or rear, only define the directions according to the accompanying drawings for the convenience of explanation but not for limitation. In addition, if one element is formed on, above, under, or below another element, these two elements can be directly contacted with each other or not directly contacted with each other but have an addition element disposed therebetween. The numeral descriptions, such as the first, the second and the third, are for identifying different components and are not for limiting the order thereof.

In order to make the following description of the disclosure more comprehensive, the related drawings of the following embodiments are marked with a first direction D1, a second direction D2 and a third direction D3. Any two of the first direction D1, the second direction D2 and the third direction D3 are substantially perpendicular to each other. For example, the first direction D1 is substantially parallel to the light input surface of the backlight module, the second direction D2 is substantially perpendicular to the light input surface of the backlight module, and the third direction D3 is perpendicular to the first direction D1 and the second direction D2 as well as the light output surface. This disclosure is not limited thereto.

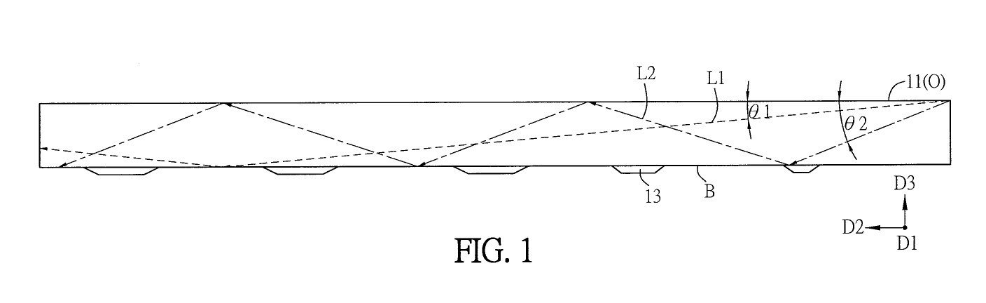

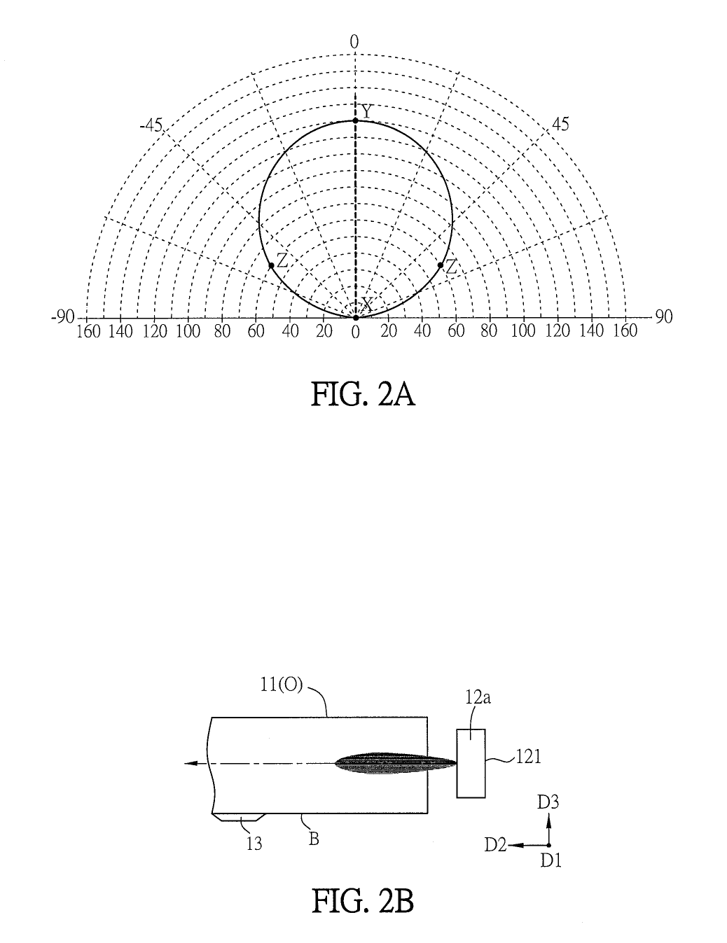

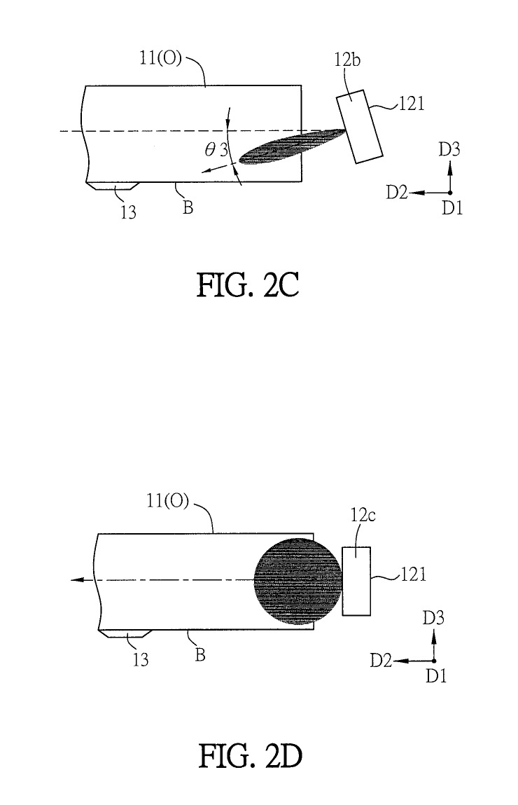

FIG. 1 is a side view of a light guiding unit according to an embodiment of the disclosure, FIG. 2A is a schematic diagram showing the illumination values of the light-emitting unit in different angles, and FIGS. 2B to 2D are side views of the light guiding units and light-emitting elements in different embodiments.

As shown in FIG. 1, the light beam L1 and the light output surface O of the light guiding unit 11 has an included angle θ1, and the light beam L2 and the light output surface O of the light guiding unit 11 has an included angle θ2. Herein, the included angle θ1 is not equal to the included angle θ2, which means the light beam L1 and the light beam L2 have different incident angles. Accordingly, the times and numbers that the light beams L1 and L2 contact the dots 13 of the bottom surface B of the light guiding unit 11 in a unit length are different. This feature can form different brightness distributions in different regions inside the light guiding unit 11 to control the local dimming

FIG. 2A shows a polar coordinates diagram, in which a curve indicates the illuminations (lux) of the light-emitting element in different angles (measured with an angle analyzer). FIG. 2A is a schematic diagram showing the illumination values of the light-emitting unit in different angles. The point X is the light output location (0 degree and 0 lux) of the light-emitting element, point Y is the maximum illumination point (0 degree and 120 lux in this embodiment) in the light output pattern of the light-emitting element, and the connecting line between the points X and Y represents an extension direction of the maximum illumination.

In this embodiment, the included angle between the incident light and the light output surface O of the light guiding unit 11 can be changed by disposing the light-emitting element in different tilt angles or using the light-emitting element with different light output patterns. The tilt angle is defined as the included angle between the second direction D2 and the extension direction of the maximum illumination of the light-emitting element in the side view of the backlight module 3 (the plane defined by the second direction D2 and the third direction D3). In one embodiment, the bottom surface 121 of the light-emitting element and the third direction D3 have an included angle (see FIG. 2C), and the light-emitting element has a tilt angle. In other embodiments (not shown), the bottom surface 121 of the light-emitting element is parallel to the third direction D3, and the extension direction of the maximum illumination of the light-emitting element and the second direction D2 have an included angle. This disclosure is not limited.

FIGS. 2B and 2C show the light-emitting elements disposed in different tilt angles. Herein, the light-emitting element is, for example but not limited to, a light-emitting diode (LED) or a micro light-emitting diode (μLED).

As shown in FIG. 2B, when the extension direction of the maximum illumination of the light-emitting element 12a is parallel to the second direction D2, the light-emitting element 12a is not tilted. As shown in FIG. 2C, when an included angle θ3 (tilt angle) is defined between the extension direction of the maximum illumination of the light-emitting element 12a and the second direction D2, the light-emitting element 12a is tilted. The light-emitting elements with different tilt angles can provide different incident angles, so that brightness will be different in different regions in the light guiding unit 11 and the local dimming could be controlled.

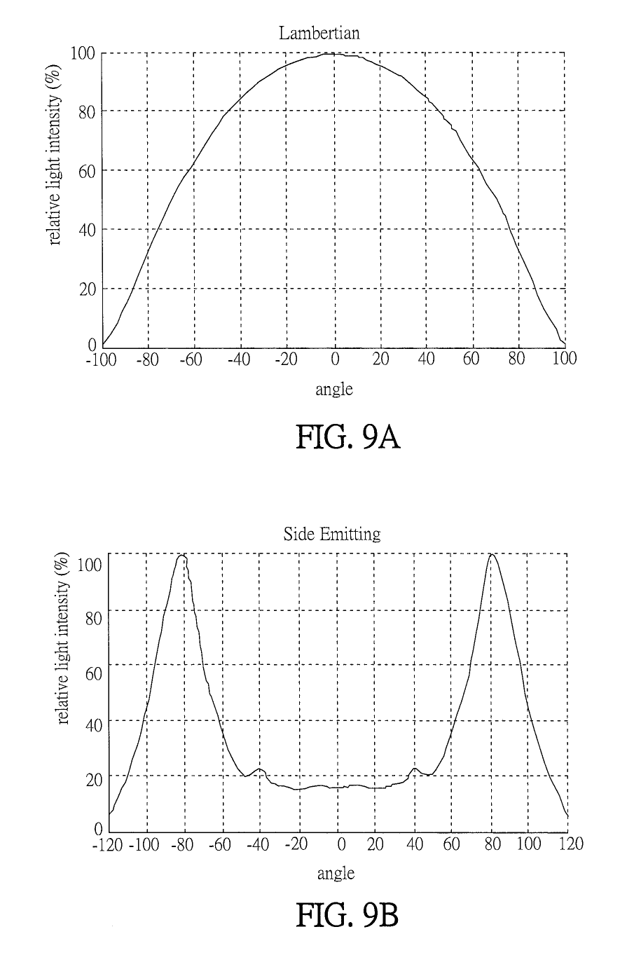

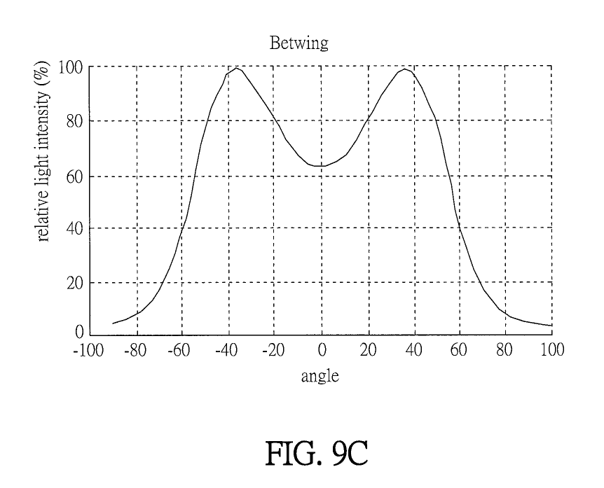

Referring to FIG. 2A, the point Z (60 degrees or −60 degrees, 60 lux) represents an FWHM (Full Width at Half Maximum) angle of the illumination of the light-emitting element, which is the width value (an angle value such as ±60° in this embodiment) of the point with a half of the maximum illumination (point Z, 60 lux). The FWHM angle of the illumination can be defined by the polar coordinates of FIG. 2A or by the Cartesian coordinates of FIG. 9A. As shown in FIG. 9A, the FWHM angle of the illumination is the width value of the point with 50% relative illumination (an angle value such as ±70° in this embodiment). Those skilled persons in the optical field can understand the meanings of the FWHM angle of the illumination, so the detailed description thereof will be omitted.

The times and numbers that the incident lights with different FWHM angle of illumination contact the dots 13 of the bottom surface B of the light guiding unit 11 in a unit length are different. FIGS. 2B and 2D show the light-emitting elements having different light output patterns. For example, as shown in the side views (the plane defined by the second direction D2 and the third direction D3) of the backlight modules 3 of FIGS. 2B and 2D, the light output patterns of the light-emitting element 12a and the light-emitting element 12c are different. The FWHM angle of illumination of the light-emitting element 12a is less than the FWHM angle of illumination of the light-emitting element 12c. Accordingly, the light-emitting element 12a has a higher incident light proportion in the direction close to θ1 of FIG. 1, and the light-emitting element 12c has a higher incident light proportion in the direction close to θ2 of FIG. 1. As a result, the times and numbers that the incident lights from the light-emitting elements 12a and 12c contact the dots 13 of the bottom surface B of the light guiding unit 11 in a unit length are different. This feature can form different brightness distributions in different regions inside the light guiding unit 11 to control the local dimming.

In other words, this disclosure can form different brightness distributions in different regions inside the light guiding unit 11 by the light emitted from different light-emitting elements, which are disposed with different tilt angles or have different light output patterns. In more specific, each light-emitting element can emit light into the light guiding unit 11 and form a maximum brightness point on the light output surface O, and the maximum brightness points of different light-emitting elements are separated. This can control the local dimming for more regions.

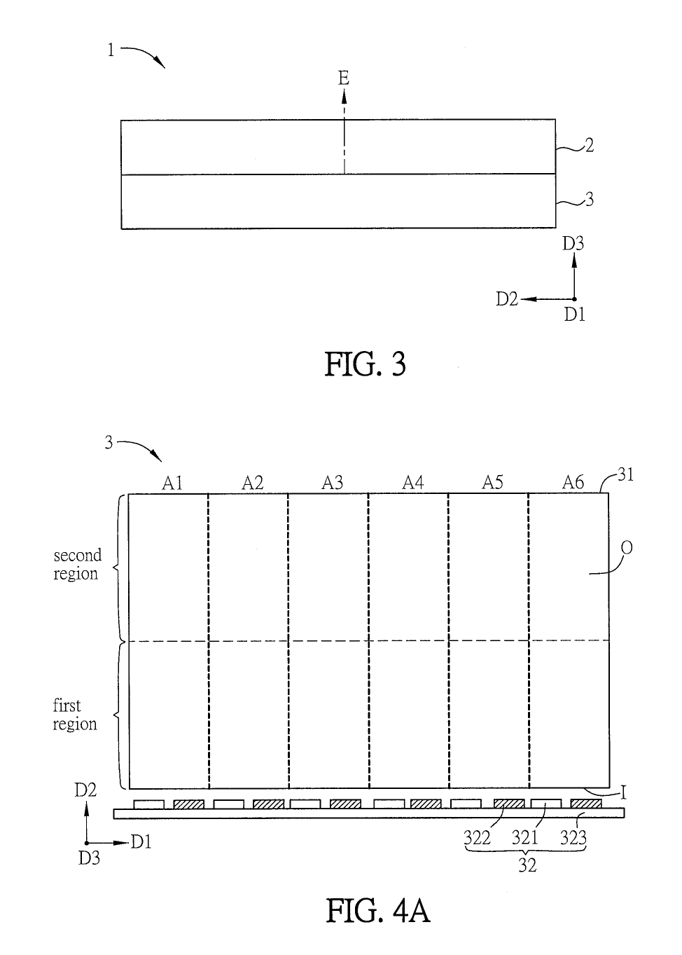

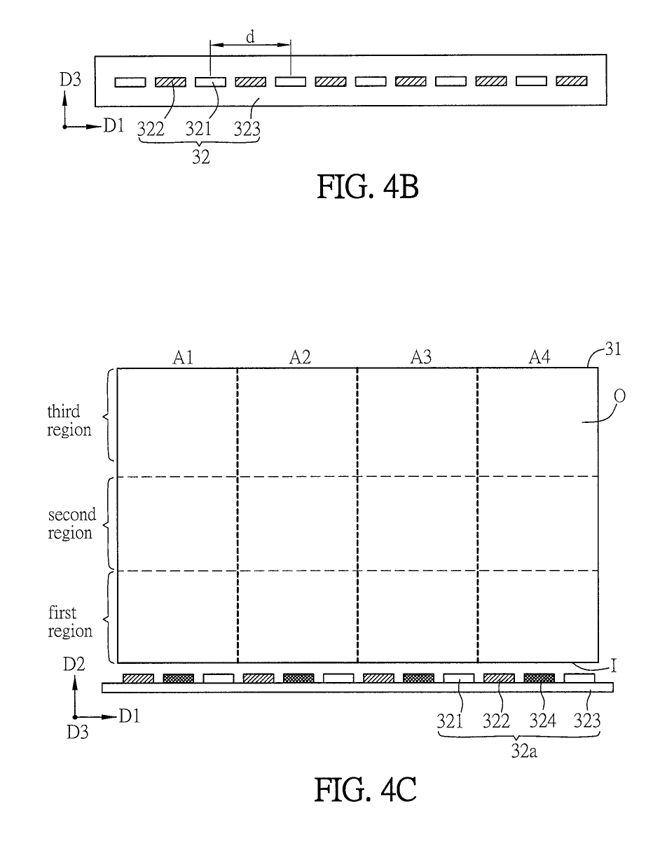

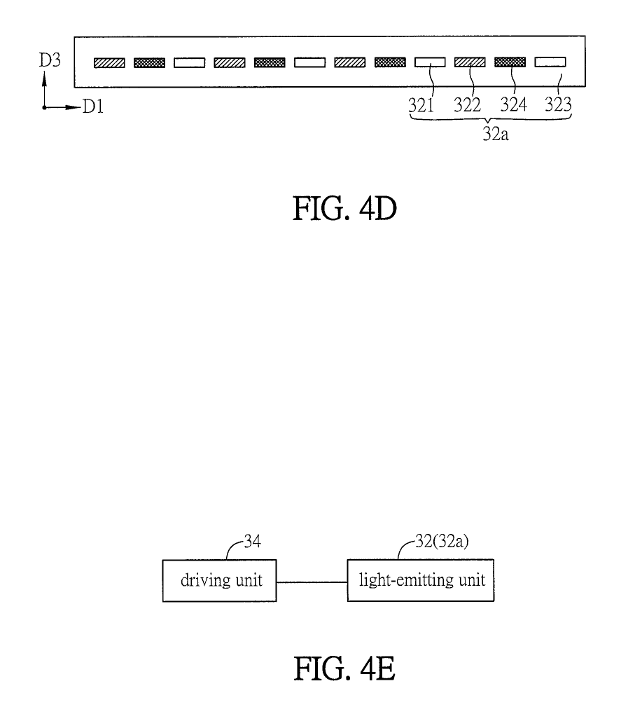

FIG. 3 is a side view of a display device 1 according to an embodiment of the disclosure, FIG. 4A is a top view of a light guiding unit and a light-emitting unit in the backlight module 3 of the display device 1 as shown in FIG. 3, and FIG. 4B is a schematic diagram showing a light-emitting unit of FIG. 4A.

As shown in FIG. 3, the display device 1 includes a display panel 2 and a backlight module 3. The backlight module 3 is disposed opposite and corresponding to the display panel 2 and is used to emit light E, which passes through the display panel 2 for displaying images.

The display panel 2 includes two substrates and a liquid crystal layer disposed between the two substrate (not shown). In this embodiment, the display panel 2 can be an FFS (Fringe Field Switching) liquid crystal display panel, an IPS (In Plane Switching) type liquid crystal display panel, a TN (Twisted Nematic) type liquid crystal display panel, a VA (Vertical Alignment) type liquid crystal display panel, or other types of liquid crystal display panels. This disclosure is not limited. Of course, this disclosure is not limited to the LCD device. In other embodiments, this disclosure can be applied to the backlight module for other kinds of display devices, such as MEMS (Micro Electro Mechanical System) display device, and this disclosure is not limited. Moreover, this disclosure can be used in other field and is not limited to the display devices. In other embodiments, this disclosure can be applied to the light source for other electronic devices, which also need the local dimming function, and this disclosure is not limited. Besides, the display device 1 of this embodiment can be a flexible display device, a touch display device, or a curved display device, and this disclosure is not limited.

As shown in FIG. 4A, the backlight module 3 includes a light guiding unit 31 and a light-emitting unit 32. Moreover, the backlight module 3 can further include an optical film assembly and a reflective unit (not shown). Those skilled persons in the LCD display field can understand the functions and configurations of the above-mentioned components, so the detailed description thereof will be omitted.

The light guiding unit 31 has at least one light input surface I, a light output surface O and a bottom surface (not shown), and the light output surface O and the bottom surface are connected to the light input surface I and disposed opposite and corresponding to each other. In this embodiment, the light input surface I is the surface of the light guiding unit 31 that the light enters the light guiding unit 31, and the light output surface O is the surface of the light guiding unit 31 that the light leaves the light guiding unit 31 and travels toward the display panel 2. Accordingly, the backlight module 3 is an edge-type backlight module. The light-emitting unit 32 is disposed adjacent to the light input surface I along a first direction D1. The first direction D1 is substantially parallel to the light input surface I. A second direction D2 is defined as a direction perpendicular to the light input surface I, and the light output surface O is parallel to the second direction D2. In addition, a third direction D3 is perpendicular to the first direction D1 and the second direction D2. The direction from the top to view the display surface of the display panel 2 can be parallel to the third direction D3.

The light guiding unit 31 is a light guiding plate and is configured for guiding the transmission direction of the light. The light will have total reflection inside the light guiding plate, and the light can enter the light guiding unit 31 via the light input surface I and be outputted via the light output surface O. In this embodiment, the light guiding element 31 is made of transparent materials, such as acrylic resin, polycarbonate, polyethylene resin, or glass, and this disclosure is not limited. In addition, the cross-section of the light guiding element 31 may have a plate shape or a wedge shape, and this disclosure is not limited.

The light-emitting unit 32 is disposed adjacent to the light input surface I of the light guiding unit 31 along the first direction D1. In this embodiment, the light-emitting unit 32 has a plurality of first light-emitting elements 321, a plurality of light-emitting elements 322 and a substrate 323. The substrate 323 is disposed along the first direction D1 and facing the light input surface I. The first light-emitting elements 321 and the second light-emitting elements 322 are disposed on the substrate 323 along the first direction D1, and the lights emitted from the first light-emitting elements 321 and the second light-emitting elements 322 enter the light guiding unit 31 via the light input surface I and leave the light guiding unit 31 via the light output surface O.

The substrate 323 includes driving circuits and can be a flexible substrate, a rigid substrate, or a rigid-flex board, and this disclosure is not limited. In this embodiment, the first light-emitting elements 321 and the second light-emitting elements 322 are light-emitting diodes (LED) or micro light-emitting diodes (μLED) having different lighting properties, respectively. In addition, the first light-emitting elements 321 and the second light-emitting elements 322 can be disposed on the substrate 323 by, for example but not limited to, SMT (Surface Mount Technology), and the light-emitting unit 32 becomes a LED lightbar or a μLED lightbar.

As shown in FIG. 4B, the first light-emitting elements 321 and the second light-emitting elements 322 of the light-emitting unit 32 can be alternately disposed in a line along the first direction D1. This disclosure is not limited thereto. In some embodiments, the first light-emitting elements 321 and the second light-emitting elements 322 of the light-emitting unit 32 can be disposed in two lines along the first direction D1. In addition, an FWHM (full width at half maximum) angle of an illumination of at least one of the first light-emitting elements 321 is different from an FWHM angle of an illumination of at least one of the second light-emitting elements 322. In this embodiment, the extension directions of the maximum illumination of the first light-emitting elements 321 and the second light-emitting elements 322 are parallel to the second direction D2. That is, the first light-emitting elements 321 and the second light-emitting elements 322 are not tilted. Besides, the FWHM angles of the illumination of the first light-emitting elements 321 are different from the FWHM angles of the illumination of the second light-emitting elements 322.

In the embodiment of FIG. 4A, the lighting properties of the first light-emitting elements 321 and the second light-emitting elements 322 are different (e.g. the FWHM angles of the illumination are different), so that the light beams emitted from the light-emitting elements 321 and 322 form the maximum brightness at different points inside the light guiding unit 31. Thus, the light guiding unit 31 can be divided into, for example, two regions along the second direction D2. For example, if the bottom surface of the light guiding unit 31 has the same dot design, the first light-emitting elements 321, which has larger FWHM angle of illumination (e.g. ±55° as shown in FIG. 2D), can obtain a forward light output effect inside the light guiding unit 31 (close to the light-emitting unit 32 such as the first region of FIG. 4A). That is, the incident light beams are mostly outputted in the first region, so that the first region is brighter while the second region is darker. In addition, the second light-emitting elements 322, which has smaller FWHM angle of illumination (e.g. ±10° as shown in FIG. 2B), can obtain a backward light output effect inside the light guiding unit 31 (away from the light-emitting unit 32 such as the second region of FIG. 4A). That is, the incident light beams are mostly outputted in the second region, so that the second region is brighter while the first region is darker. In this embodiment, one first light-emitting element 321 and one adjacent second light-emitting element 322 are set as a group. Thus, it is possible to obtain the regions A1 to A6 in the light guiding unit 31 along the first direction D1. By driving the first light-emitting elements 321 and the second light-emitting elements 322 in the regions A1 to A6 individually, in each of the regions A1 to A6, the following situations can be controlled such as: the first region is dark and the second region is dark; the first region is bright and the second region is dark; the first region is dark and the second region is bright; or the first region is bright and the second region is bright. This is possible to control the bright or dark of the first region and the second region in the regions A1 to A6. In other embodiments, two adjacent first light-emitting elements 321 and two adjacent second light-emitting elements 322 are a group. Thus, it is possible to obtain three regions in the light guiding unit 31 along the first direction D1. In this disclosure, it is possible to set multiple adjacent first light-emitting elements 321 and multiple adjacent second light-emitting elements 322 as one group so as to obtain multiple regions along the first direction D1, and this disclosure is not limited. Accordingly, the disclosure can control the local dimming to divide the light guiding unit 31 into two regions along the second direction D2. Compared with the conventional single-sided edge-type backlight module, which divides the light guiding unit 31 into one region along the second direction D2, the single-sided edge-type backlight module of the disclosure can increase the total divided regions for local dimming

FIG. 4C is a top view of a light guiding unit 31 and a light-emitting unit 32a according to another embodiment of the disclosure, and FIG. 4D is a schematic diagram showing the light-emitting unit 32a of FIG. 4C.

As shown in FIGS. 4C and 4D, the light-emitting unit 32a includes a plurality of first light-emitting elements 321, a plurality of light-emitting elements 322 and a plurality of third light-emitting elements 324. The third light-emitting elements 324 are also disposed on the substrate 323 along the first direction D1 and emit light into the light guiding unit 31 via the light input surface I. In this embodiment, the first light-emitting elements 321, the second light-emitting elements 322 and the third light-emitting elements 324 are alternately arranged along the first direction D1. The FWHM angle of the illumination of at least one of the first light-emitting elements 321, the FWHM angle of the illumination of at least one of the second light-emitting elements 322, and the FWHM angle of the illumination of at least one of the third light-emitting elements 324 are different. In this embodiment, The FWHM angles of the illumination of the first light-emitting elements 321, the FWHM angles of the illumination of the second light-emitting elements 322, and the FWHM angles of the illumination of the third light-emitting elements 324 are different. Accordingly, the light guiding unit 31 can be divided into three regions along the second direction D2. For example, if the bottom surface of the light guiding unit 31 has the same dot design, the first light-emitting elements 321, which has larger FWHM angle of illumination (e.g. ±60°), can obtain a forward light output effect inside the light guiding unit 31 (close to the light-emitting unit 32a such as the first region of FIG. 4C). That is, the incident light beams are mostly outputted in the first region, so that the first region is brighter while the second region and the third region are darker. In addition, the second light-emitting elements 322, which has smaller FWHM angle of illumination (e.g. ±8°), can obtain a backward light output effect inside the light guiding unit 31 (away from the light-emitting unit 32a such as the third region of FIG. 4C). That is, the incident light beams are mostly outputted in the third region, so that the third region is brighter while the first region and the second region are darker. Moreover, the third light-emitting elements 324, which has an FWHM angle of illumination (e.g. ±30°) between the FWHM angles of the first light-emitting elements 321 and the second light-emitting elements 322, can obtain a middle light output effect inside the light guiding unit 31 (between the first region and the third region, such as the second region of FIG. 4C). That is, the incident light beams are mostly outputted in the second region, so that the second region is brighter while the first region and the third region are darker.

In this embodiment, one first light-emitting element 321, one second light-emitting element 322 and one third light-emitting element 324, which are disposed adjacent to each other, are set as a group. Thus, it is possible to obtain the regions A1 to A4 in the light guiding unit 31 along the first direction D1. By driving the first light-emitting elements 321, the second light-emitting elements 322, and the third light-emitting elements 324 in the regions A1 to A4 individually, the bright and dark statuses of the first region, the second region and the third region in each of the regions A1 to A4 can be controlled separately. In other embodiments, two first light-emitting elements 321, two second light-emitting elements 322 and two third light-emitting elements 324, which are disposed adjacent to each other, are set as a group. Thus, it is possible to obtain two regions in the light guiding unit 31 along the first direction D1. In this disclosure, it is possible to set multiple adjacent first light-emitting elements 321, multiple adjacent second light-emitting elements 322, and multiple adjacent third light-emitting elements 324 as one group so as to obtain multiple regions along the first direction D1, and this disclosure is not limited. Accordingly, the disclosure can control the local dimming to divide the light guiding unit 31 into three regions along the second direction D2. Compared with the conventional single-sided edge-type backlight module, which divides the light guiding unit 31 into one region along the second direction D2, the single-sided edge-type backlight module of the disclosure can increase the total divided regions for local dimming.

In another embodiment, an extension direction of a maximum illumination of at least one of the first light-emitting elements 321 and an extension direction of a maximum illumination of at least one of the second light-emitting elements 322 are parallel to the second direction D2. An included angle is defined between the second direction D2 and an extension direction of a maximum illumination of at least one of the third light-emitting elements 324, and the included angle is greater than 0 degree and less than 90 degrees. In this embodiment, the first light-emitting elements 321 and the second light-emitting elements 322 are not tilted, and the FWHM angles of the illumination of the first light-emitting elements 321 are different from the FWHM angles of the illumination of the second light-emitting elements 322. For example, the FWHM angles of the illumination of the first light-emitting elements 321 are ±55°, and the FWHM angles of the illumination of the second light-emitting elements 322 are ±10°. The FWHM angles of the illumination of the third light-emitting elements 324 are the same as the FWHM angles of the illumination of the second light-emitting elements 322 (±10°), and an included angle is defined between the second direction D2 and the extension direction of the maximum illumination of the third light-emitting elements 324. That is, the third light-emitting elements 324 are tilted, and the included angle is θ3 as shown in FIG. 2C, which can be greater than 0 degree and less than 90 degrees (0°<θ3<90°). In one embodiment, the included angle θ3 is 17°. In other words, the first light-emitting elements 321 and the second light-emitting elements 322 are not tilted, and the third light-emitting elements 324 are tilted. Accordingly, the light guiding unit 31 can be divided into three regions along the second direction D2 to control local dimming.

In other embodiments, the included angle between the second direction D2 and the extension direction of the maximum illumination of at least one of the first light-emitting elements 321 is different from the included angle between the second direction D2 and the extension direction of the maximum illumination of at least one of the second light-emitting elements 322. For example, the included angle θ3 of the first light-emitting elements 321 is 0 degree, and the included angle θ3 of the second light-emitting elements 322 is 30 degrees. This configuration can divide the light guiding unit 31 into two regions along the second direction D2. In other embodiments, the included angle (0 degree) between the second direction D2 and the extension direction of the maximum illumination of the first light-emitting elements 321, the included angle (17 degrees) between the second direction D2 and the extension direction of the maximum illumination of the second light-emitting elements 322, and the included angle (40 degrees) between the second direction D2 and the extension direction of the maximum illumination of the third light-emitting elements 324 are different. This configuration can divide the light guiding unit 31 into three regions along the second direction D2. In other embodiments, the included angle (0 degree) between the second direction D2 and the extension direction of the maximum illumination of the first light-emitting elements 321 is different from the included angle (17 degrees) between the second direction D2 and the extension direction of the maximum illumination of the second light-emitting elements 322, and the FWHM angles of the first light-emitting elements 321 and the second light-emitting elements 322 are the same (±10°). Besides, the FWHM angle of the illumination of the third light-emitting elements 324 is different from the FWHM angle of the illumination of the first light-emitting elements 321 or the second light-emitting elements 322. This configuration can also divide the light guiding unit 31 into three regions along the second direction D2. This disclosure is not limited thereto.

The above-mentioned aspects are for some illustrations. This disclosure can use different light sources to allow the light-emitting elements to provide different FWHM angles of the illumination, different tilt angles, or any other the combinations thereof. Then, the light beams emitted from the light-emitting elements can form the maximum brightness at different points inside the light guiding unit 31 according to the local dimming control method. Accordingly, the light guiding unit 31 can have the local dimming effect of two regions, three regions, four regions or more along the second direction D2.

To be noted, in order to control the local dimming, as shown in FIG. 4E, the backlight module 3 further includes a driving unit 34 electrically connected to the light-emitting unit 32 or 32a. The driving unit 34 can individually drive the first light-emitting elements 321, the second light-emitting elements 322 and the third light-emitting elements 324. For example, as shown in FIG. 4A, the backlight module 3 is divided into the regions A1 to A6 along the first direction D1, and each region is cooperated with one first light-emitting element 321 and one adjacent second light-emitting element 322 to achieve the dividing effect along the second direction D2. Thus, the first light-emitting element 321 and the second light-emitting element 322 in each region can be separately driven. In the conventional single-sided edge-type backlight module, the backlight module contains the same kind of light-emitting elements. Accordingly, if one region has, for example, two light-emitting elements, these light-emitting elements of the same region are driven simultaneously. Thus, the driving method of the conventional backlight module is different from this disclosure. In other words, this disclosure has a driving unit 34 for individually and separately driving the first light-emitting elements 321, the second light-emitting elements 322 and the third light-emitting elements 324, thereby achieving the goal to control local dimming.

In order to prevent the hotspot issue, in the embodiment of FIG. 4A, the distance d between centers of two of the first light-emitting elements 321 (or two of the second light-emitting elements 322) is greater than 0 mm and less than or equal to 16 mm (0 mm<d≤16 mm). This configuration can prevent the non-uniform light mixing issue at the light input surface due to the large distance d, which may cause the undesired hotspot issue. Besides, the FWHM angles of the illumination of the first light-emitting elements 321, the second light-emitting elements 322 and the third light-emitting elements 324 along the first direction D1 are preferably larger for preventing the undesired hotspot issue. In some embodiments, the FWHM angle of the illumination of at least one of the first light-emitting elements 321 along the third direction D3 is less than or equal to the FWHM angle of the illumination of the first light-emitting element 321 along the first direction D1. The FWHM angle of the illumination of at least one of the second light-emitting elements 322 along the third direction D3 is less than or equal to the FWHM angle of the illumination of the second light-emitting element 322 along the first direction D1. In this embodiment, the FWHM angles of the illumination of the first light-emitting elements 321 along the third direction D3 are less than or equal to the FWHM angles of the illumination of the first light-emitting elements 321 along the first direction D1. The FWHM angles of the illumination of the second light-emitting elements 322 along the third direction D3 are less than or equal to the FWHM angles of the illumination of the second light-emitting elements 322 along the first direction D1. The FWHM angles of the illumination of the third light-emitting elements 324 along the third direction D3 are less than or equal to the FWHM angles of the illumination of the third light-emitting elements 324 along the first direction D1. This configuration can reduce the hotspot issue caused by the non-uniform light mixing.

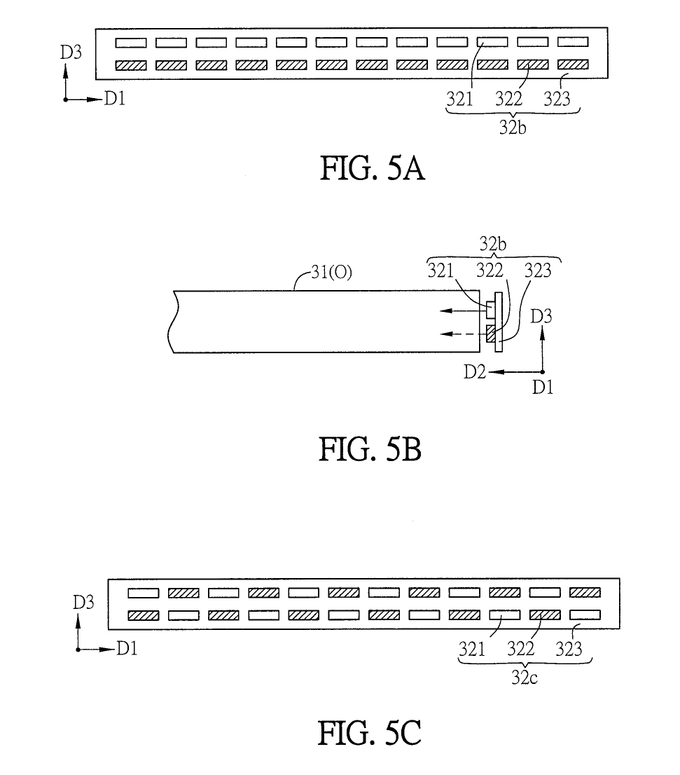

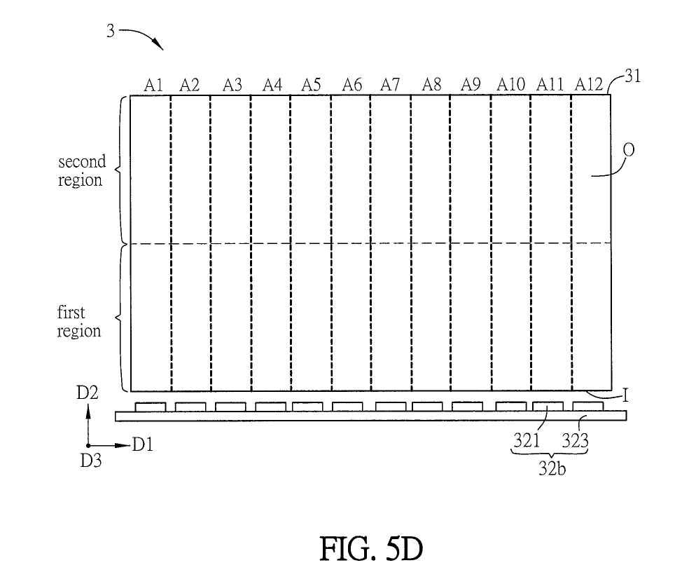

FIGS. 5A and 5C are schematic diagrams showing the light-emitting units of different aspects, FIG. 5B is a side view of the light guiding unit and the light-emitting element of another embodiment, and FIG. 5D is a top view of the light guiding unit and the light-emitting element according to another embodiment of the disclosure.

As shown in FIGS. 5A and 5B, the first light-emitting elements 321 of the light-emitting unit 32b are arranged in a line along the first direction D1, and the second light-emitting elements 322 of the light-emitting unit 32b are also arranged in a line along the first direction D1. The line of the first light-emitting elements 321 is parallel to the line of the second light-emitting elements 322. Alternatively, as shown in FIG. 5C, the first light-emitting elements 321 and the second light-emitting elements 322 are alternately arranged in the upper line along the first direction D1, and the first light-emitting elements 321 and the second light-emitting elements 322 are also alternately arranged in the lower line along the first direction D1. In a line along the third direction D3, the light-emitting element of the upper line is different from the light-emitting element of the lower line. In other embodiments (not shown), the first light-emitting elements 321 and the second light-emitting elements 322 are alternately arranged as shown in FIG. 5C, but the light-emitting elements 321 and the second light-emitting elements 322 are not aligned along the third direction D3. The arrangement of the light-emitting elements is not limited in this disclosure.

In this embodiment, as shown in FIGS. 5A and 5D, in the light-emitting unit 32b, one first light-emitting element 321 and one adjacent second light-emitting element 322 are set as a group. Since the first light-emitting elements 321 and the second light-emitting elements 322 are arranged in parallel, it is possible to obtain, for example, the regions A1 to A12 in the light guiding unit 31 along the first direction D1. In other embodiments, two first light-emitting elements 321 and two second light-emitting elements 322, which are disposed adjacent to each other, are set as a group. Thus, it is possible to obtain six regions in the light guiding unit 31 along the first direction D1. In this disclosure, it is possible to set multiple adjacent first light-emitting elements 321 and multiple adjacent second light-emitting elements 322 as one group so as to obtain multiple regions along the first direction D1, and this disclosure is not limited. Accordingly, the disclosure can control the local dimming to divide each of the regions A1 to A12 of the light guiding unit 31 into two regions along the second direction D2. Compared with the conventional single-sided edge-type backlight module, which divides the light guiding unit 31 into one region along the second direction D2, the single-sided edge-type backlight module of the disclosure can increase the total divided regions for local dimming

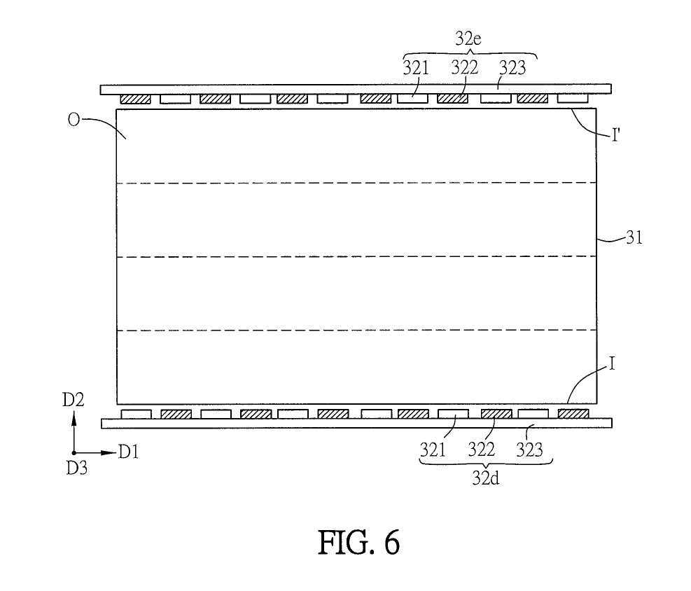

In the above-mentioned embodiments, one light-emitting unit is disposed adjacent to one light input surface of the light guiding unit 31. In other embodiments, another light-emitting unit can be disposed at another (light input) surface of the light guiding unit 31, which is located opposite to the light input surface, and the lights emitted from the two light-emitting units can enter the light guiding unit 31 through the opposite light input surfaces, respectively, for achieving the local dimming effect with more regions. FIG. 6 is a top view of the light guiding unit and the light-emitting unit according to another embodiment of the disclosure.

As shown in FIG. 6, in this embodiment, a light-emitting unit 32d is disposed adjacent to the light input surface I of the light guiding unit 31, and another light-emitting unit 32e is disposed adjacent to another light input surface I′, which is located opposite to the light input surface I. Accordingly, the lights emitted from the two light-emitting units 32d and 32e can enter the light guiding unit 31 through the opposite light input surfaces I and I′, respectively, for obtaining four regions along the second direction D2 to achieve the local dimming effect. In another embodiment, each of the light-emitting units includes a plurality of first light-emitting elements 321, a plurality of second light-emitting elements 322 and a plurality of third light-emitting elements 324, so that it is possible to obtain three regions for local dimming. This configuration can divide the light guiding unit 31 into, for example, six regions along the second direction D2, and this disclosure is not limited.

In the above embodiments, the light-emitting units are disposed at the top side and/or the bottom side of the light guiding unit 31. In other embodiments, the light-emitting units can be disposed at the left side and/or the right side of the light guiding unit 31 for achieving the desired local dimming effect along the first direction D1. Accordingly, the designer can optionally utilize the light-emitting elements with different FWHM angles of illumination or different tilt angles to form the light-emitting unit, so that the light beams emitted from the light-emitting elements can form the maximum brightness at different points inside the light guiding unit 31, thereby achieving the desired local dimming effect to form multiple regions inside the light guiding unit along one direction.

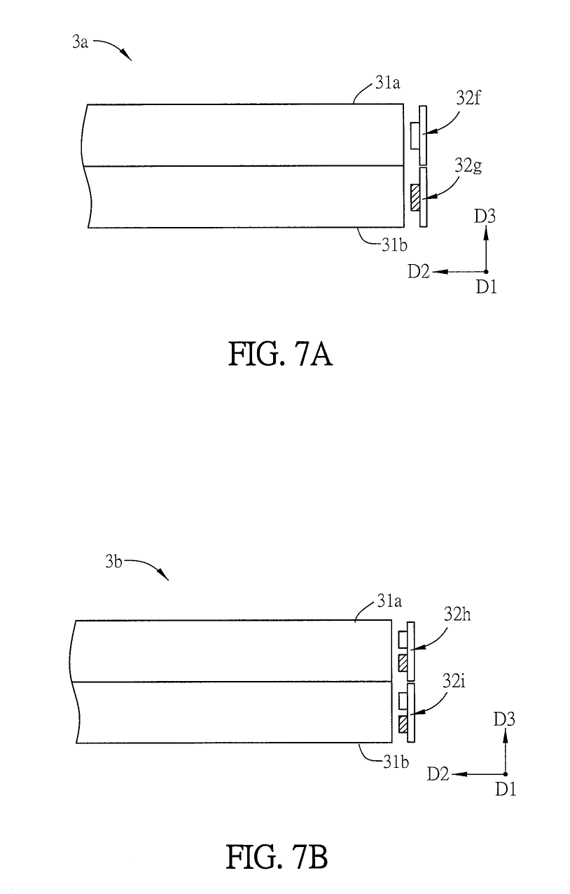

FIGS. 7A and 7B are side views of the backlight modules (the light guiding unit and the light-emitting unit) of different aspects of the disclosure.

In the embodiment of FIG. 7A, the backlight module 3a includes two light guiding units 31a and 31b and two light-emitting units 32f and 32g. The light guiding unit 31a is stacked on the light guiding unit 31b. The light-emitting unit 32f can emit light into the light guiding unit 31a, and the light-emitting unit 32g can emit light into the light guiding unit 31b. For example, if the light-emitting unit 32f can divide the light guiding unit 31a into two regions and the light-emitting unit 32g can divide the light guiding unit 31b into two regions, the backlight module 3a can totally have four regions. Alternatively, if the light-emitting unit 32f can divide the light guiding unit 31a into three regions and the light-emitting unit 32g can divide the light guiding unit 31b into three regions, the backlight module 3a can totally have six regions. In another aspect, if the light-emitting unit 32f can divide the light guiding unit 31a into two regions and the light-emitting unit 32g can divide the light guiding unit 31b into three regions, the backlight module 3a can totally have five regions. This disclosure is not limited.

In the embodiment of FIG. 7B, the backlight module 3b includes two light guiding units 31a and 31b and two light-emitting units 32h and 32i. The light guiding unit 31a is stacked on the light guiding unit 31b. The light-emitting unit 32h can emit light into the light guiding unit 31a, and the light-emitting unit 32i can emit light into the light guiding unit 31b. For example, if the light-emitting unit 32h can divide the light guiding unit 31a into two regions and the light-emitting unit 32i can divide the light guiding unit 31b into two regions, the backlight module 3b can totally have four regions. Alternatively, if the light-emitting unit 32h can divide the light guiding unit 31a into three regions and the light-emitting unit 32i can divide the light guiding unit 31b into three regions, the backlight module 3b can totally have six regions. In another aspect, if the light-emitting unit 32h can divide the light guiding unit 31a into four regions and the light-emitting unit 32i can divide the light guiding unit 31b into four regions, the backlight module 3b can totally have eight regions. This disclosure is not limited.

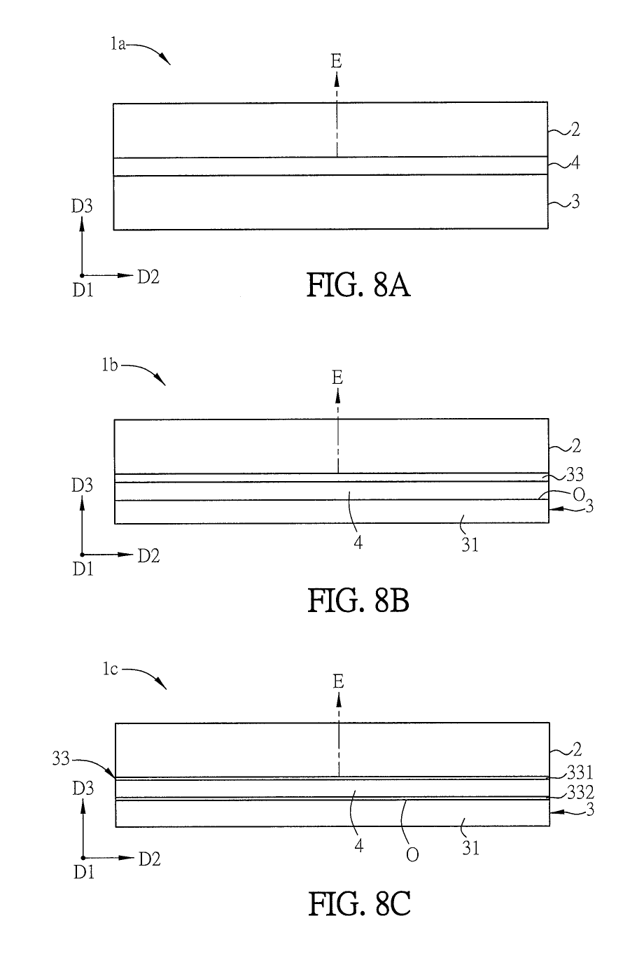

FIGS. 8A to 8C are side views of the display devices 1a, 1b and 1c of different embodiments of the disclosure.

In one embodiment of the disclosure, the backlight module 3 includes a white light source (e.g. a white light LED). In other embodiments, the backlight module 3 may include a light source emitting another color light (e.g. a blue light LED) and a layer for converting the wavelength of the light (e.g. a quantum dot layer or a phosphor layer), which can convert the light emitted from the light source into a white light. For example, as shown in FIG. 8A, the display device 1 further includes a photoluminescence layer 4 disposed between the display panel 2 and the backlight module 3. Herein, the photoluminescence layer 4 is, for example, a quantum dot structure or a phosphor layer. In this embodiment, the photoluminescence layer 4 is a quantum dot structure, which can absorb the light (e.g. blue light) emitted from the light-emitting elements of the backlight module 3. When the size of the quantum dots is large, it can emit red light, and when the size of the quantum dots is small, it can emit green light. Accordingly, it is possible to generate the light with different colors (e.g. blue light, red light, and green light) by utilizing the quantum dots of different sizes, thereby obtaining the visible light (e.g. white light) after light mixing. The generated light can pass through the display panel 2 to display the image. In other embodiments, the light-emitting elements of the backlight module 3 emit a UV light and the photoluminescence layer 4 is a phosphor layer, so that the light of different colors (e.g. red, green and blue) can be generated after passing through the phosphor layer, thereby obtaining the white light after light mixing. In other embodiments, the light-emitting elements emit blue light and the photoluminescence layer 4 is a yellow phosphor layer, so that the white light can be generated after passing through the yellow phosphor layer. The above-mentioned color light sources and the corresponding photoluminescence layers 4 are for illustrations and this disclosure is not limited.

As shown in FIG. 8B, the backlight module 3 further includes an optical film assembly 33, which includes at least one optical film and is disposed corresponding to the light output surface O of the light guiding unit 31. In this embodiment, the photoluminescence layer 4 is disposed between the optical film assembly 33 and the light guiding unit 31. In addition, the photoluminescence layer 4 is, for example, a quantum dot structure for absorbing the light emitted from the light-emitting elements (not shown) of the backlight module 3. Accordingly, the photoluminescence layer 4 can generate the white light, which passes through the optical film assembly 33 and the display panel 2 so as to display the image. In other embodiments, as shown in FIG. 8C, the photoluminescence layer 4 can be disposed between any two optical films 331 and 332 of the optical film assembly 33, and this disclosure is not limited.

FIGS. 9A to 9C are schematic diagrams showing the light patterns of three different light sources.

In the above embodiments, the light-emitting elements have at least two different FWHM angles of illuminations or at least two different tilting angles, so that the light beams emitted from the light-emitting elements can form the maximum brightness at different points inside the light guiding unit, thereby achieving the desired local dimming The above embodiments utilize the Lambertian light source as shown in FIG. 9A, which has one peak (one point with the maximum brightness), and this disclosure is not limited. In addition, this disclosure can be applied to the side emitting light source as shown in FIG. 9B, which has two peaks (two points with the maximum brightness), or the betwing light source as shown in FIG. 9C, which has two peaks (two points with the maximum brightness). Of course, other kinds of light sources can be used in this disclosure for forming the maximum brightness at different points to control the local dimming. This disclosure is not limited.

In summary, the display device of the disclosure has the light-emitting elements with at least two different FWHM angles of illuminations or at least two different tilting angles, so that the light emitted from the light-emitting elements can form the maximum brightness at different locations inside the light guiding unit. This configuration can increase the available numbers of local dimming regions, thereby achieving the goals of compensating the image, enhancing the dynamic contrast or reducing the power consumption.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A display device, comprising:
a display panel; and
a backlight module disposed corresponding to the display panel and comprising a light guiding unit and a light-emitting unit, wherein the light guiding unit has a light input surface, the light-emitting unit is disposed adjacent to the light input surface along a first direction, the light-emitting unit has a plurality of first light-emitting elements, a plurality of second light-emitting elements and a substrate, and the first light-emitting elements and the second light-emitting elements are disposed on the substrate along the first direction and emit light into the light guiding unit via the light input surface;
wherein an FWHM (full width at half maximum) angle of an illumination of at least one of the first light-emitting elements is different from an FWHM angle of an illumination of at least one of the second light-emitting elements.

2. The display device of claim 1, wherein the light-emitting unit further comprises a plurality of third light-emitting elements, the third light-emitting elements are disposed on the substrate along the first direction and emit light into the light guiding unit via the light input surface, a second direction is a direction perpendicular to the light input surface, an extension direction of a maximum illumination of the at least one of the first light-emitting elements and an extension direction of a maximum illumination of the at least one of the second light-emitting elements are parallel to the second direction, an included angle is defined between the second direction and an extension direction of a maximum illumination of at least one of the third light-emitting elements, and the included angle is greater than 0 degree and less than 90 degrees.

3. The display device of claim 1, wherein the light-emitting unit further comprises a plurality of third light-emitting elements, the third light-emitting elements are disposed on the substrate along the first direction and emit light into the light guiding unit via the light input surface, and the FWHM angle of the illumination of the at least one of the first light-emitting elements, the FWHM angle of the illumination of the at least one of the second light-emitting elements and an FWHM angle of an illumination of at least one of the third light-emitting elements are different.

4. The display device of claim 1, wherein the first light-emitting elements and the second light-emitting elements are alternately arranged or arranged in parallel.

5. The display device of claim 1, wherein a distance between centers of two of the first light-emitting elements or two of the second light-emitting elements is greater than 0 mm and less than or equal to 16 mm.

6. The display device of claim 1, wherein a second direction is a direction perpendicular to the light input surface, a third direction is perpendicular to the first direction and the second direction, and an FWHM angle of the illumination of the at least one of the first light-emitting elements along the third direction is less than or equal to an FWHM angle of the illumination of the at least one of the first light-emitting elements along the first direction.

7. The display device of claim 1, wherein a second direction is a direction perpendicular to the light input surface, a third direction is perpendicular to the first direction and the second direction, and an FWHM angle of the illumination of the at least one of the second light-emitting elements along the third direction is less than or equal to an FWHM angle of the illumination of the at least one of the second light-emitting elements along the first direction.

8. The display device of claim 1, wherein the light-emitting unit further comprises a plurality of third light-emitting elements, the third light-emitting elements are disposed on the substrate along the first direction and emit light into the light guiding unit via the light input surface, a second direction is a direction perpendicular to the light input surface, a third direction is perpendicular to the first direction and the second direction, an FWHM angle of an illumination of at least one of the third light-emitting elements along the third direction is less than or equal to an FWHM angle of the illumination of the at least one of the third light-emitting elements along the first direction.

9. The display device of claim 1, wherein the backlight module further comprises a driving unit electrically connected to the light-emitting unit and individually driving the first light-emitting elements and the second light-emitting elements to emit light.

10. The display device of claim 1, wherein the backlight module further comprises an optical film assembly, and the display device further comprises:
a photoluminescence layer disposed between the display panel and the backlight module, between the optical film assembly and the light guiding unit, or between two optical films of the optical film assembly.

11. A display device, comprising:
a display panel; and
a backlight module disposed corresponding to the display panel and comprising a light guiding unit and a light-emitting unit, wherein the light guiding unit has a light input surface, the light-emitting unit is disposed adjacent to the light input surface along a first direction, the light-emitting unit has a plurality of first light-emitting elements, a plurality of second light-emitting elements and a substrate, the first light-emitting elements and the second light-emitting elements are disposed on the substrate along the first direction and emit light into the light guiding unit via the light input surface, and a second direction is a direction perpendicular to the light input surface;
wherein an included angle between the second direction and an extension direction of a maximum illumination of at least one of the first light-emitting elements is different from an included angle between the second direction and an extension direction of a maximum illumination of at least one of the second light-emitting elements.

12. The display device of claim 11, wherein the light-emitting unit further comprises a plurality of third light-emitting elements, the third light-emitting elements are disposed on the substrate along the first direction and emit light into the light guiding unit via the light input surface, and an FWHM angle of an illumination of at least one of the third light-emitting elements is different from an FWHM angle of the illumination of the at least one of the first light-emitting elements or the at least one of the second light-emitting elements.

13. The display device of claim 11, wherein the light-emitting unit further comprises a plurality of third light-emitting elements, the third light-emitting elements are disposed on the substrate along the first direction and emit light into the light guiding unit via the light input surface, and the included angle between the second direction and the extension direction of the maximum illumination of the at least one of the first light-emitting elements, the included angle between the second direction and the extension direction of the maximum illumination of the at least one of the second light-emitting elements, and an included angle between the second direction and an extension direction of a maximum illumination of at least one of the third light-emitting elements are different.

14. The display device of claim 11, wherein the first light-emitting elements and the second light-emitting elements are alternately arranged or arranged in parallel.

15. The display device of claim 11, wherein a distance between centers of two of the first light-emitting elements or two of the second light-emitting elements is greater than 0 mm and less than or equal to 16 mm.

16. The display device of claim 11, wherein a third direction is perpendicular to the first direction and the second direction, and an FWHM angle of the illumination of the at least one of the first light-emitting elements along the third direction is less than or equal to an FWHM angle of the illumination of the at least one of the first light-emitting elements along the first direction..

17. The display device of claim 11, wherein a third direction is perpendicular to the first direction and the second direction, and an FWHM angle of the illumination of the at least one of the second light-emitting elements along the third direction is less than or equal to an FWHM angle of the illumination of the at least one of the second light-emitting elements along the first direction.

18. The display device of claim 11, wherein the light-emitting unit further comprises a plurality of third light-emitting elements, the third light-emitting elements are disposed on the substrate along the first direction and emit light into the light guiding unit via the light input surface, a third direction is perpendicular to the first direction and the second direction, an FWHM angle of the illumination of at least one of the third light-emitting elements along the third direction is less than or equal to an FWHM angle of the illumination of the at least one of the third light-emitting elements along the first direction.

19. The display device of claim 11, wherein the backlight module further comprises a driving unit electrically connected to the light-emitting unit and individually driving the first light-emitting elements and the second light-emitting elements to emit light.

20. The display device of claim 11, wherein the backlight module further comprises an optical film assembly, and the display device further comprises:
a photoluminescence layer disposed between the display panel and the backlight module, between the optical film assembly and the light guiding unit, or between two optical films of the optical film assembly.
